(19) United States
(12) Patent Application Publication
(10) Pub. No.: US 2012/0090393 A1
(43) Pub. Date: Apr. 19, 2012

(54) UNSTABLE ELECTROSTATIC SPRING ACCELEROMETER

(75) Inventors: Josep Montanya Silvestre, Rubi (ES); Daniel Fernandez Martinez, Barcelona (ES)

(73) Assignee: Baolab Microsystems SL, Terrassa (ES)

(21) Appl. No.: 13/163,860

(22) Filed: Jun. 20, 2011

Related U.S. Application Data
(60) Provisional application No. 61/356,272, filed on Jun. 18, 2010.

(51) Int. Cl. G01P 15/13

(52) U.S. Cl. 73/514.18

(57) ABSTRACT

The systems and methods described herein address deficiencies in the prior art by enabling the fabrication and use of accelerometers, whether MEMS-based, NEMS-based, or CMOS-MEMS based, in the same integrated circuit die as a CMOS chip. In one embodiment, the accelerometer is fabricated on the same integrated circuit die as a CMOS chip using a typical CMOS manufacturing process.

### CROSS-REFERENCE TO RELATED APPLICATIONS

This Application claims the benefit of U.S. Provisional Patent Application Ser. No. 61/356,272 filed on Jun. 18, 2010, which is incorporated by reference herein in its entirety.

### BACKGROUND

Currently, micro- and nano-scale devices such as accelerometers are typically fabricated and packaged separately from a CMOS chip to which they are connected. They are made using MEMS manufacturing processes which are incompatible with typical CMOS manufacturing processes. Connecting the separate accelerometer package with a CMOS chip (e.g., having control circuitry to operate the accelerometer) yields a larger device and provides more opportunities for process errors and introduction of noise into the system. Accordingly, there is a need for systems and methods for fabricating an accelerometer and a CMOS chip together in an integrated device using the same manufacturing process, such as a typical CMOS manufacturing process.

### SUMMARY

The systems and methods described herein address deficiencies in the prior art by enabling the fabrication and use of accelerometers, whether MEMS-based, NEMS-based, or CMOS-MEMS based, in the same integrated circuit die as a CMOS chip. In one embodiment, the accelerometer is fabricated on the same integrated circuit die as a CMOS chip using a typical CMOS manufacturing process.

In one aspect, an accelerometer includes a top electrode, a bottom electrode, and a proof mass between the top and bottom electrodes. The proof mass is integrally formed with springs that hold the proof mass in place. In one configuration, a voltage is applied to the bottom electrode to reduce the effective spring constant associated with the proof mass. The applied voltage generates an electrostatic force to counter the mechanical spring constant of the springs integrally formed with the proof mass. In another configuration, voltages are applied to the top and bottom electrodes to partially or fully offset the mechanical forces of the integrally formed springs as well as the generated electrostatic forces. In this arrangement, even a small force due to an external acceleration is noticeable by causing movement of the proof mass. This enables the accelerometer to accurately measure acceleration free of other forces. The force due to external acceleration dictates the direction the proof mass. The force due to external acceleration also influences the time taken for the proof mass to reach a preset position. The measurement of this time can be used to determine the external acceleration.

In some embodiments, the accelerometer employs a smaller proof mass, and uses metal for certain components, such as the proof mass or a spring. Very small capacitance variations in the proof mass are sensed via a charge amplifier, which can compensate for a small proof mass and capacitance associated with the small proof mass. The charge amplifier may be monolithically integrated with the accelerometer. For example, the charge amplifier can be integrated in a chip having a MEMS accelerometer and other CMOS electronic circuitry.

In some embodiments, the fabricated accelerometer device has the ability to perform a calibration automatically to compensate for possible property changes of components over time or to compensate for process variations during device manufacture. An autocalibration circuit and/or process is used to automatically and/or periodically calibrate the accelerometer. Various techniques can be employed to measure the acceleration and associated parameters, regardless of the MEMS manufacturing technique or the types of components used.

In another aspect, the systems and methods described herein relate to a method for operating a MEMS accelerometer having a proof mass. The method includes periodically applying a first voltage to a first electrode positioned proximate to the proof mass. This applies an electrostatic force to the proof mass to draw the proof mass towards a preset position between a rest position and the first electrode. The method includes receiving an external acceleration at the accelerometer. The external acceleration may alter a time the proof mass takes to reach the preset position in response to the applied voltage. The method includes determining that the proof mass has reached the preset position. The method includes measuring a time taken for the proof mass to reach the preset position. The method includes determining a magnitude and direction of the external acceleration based on the measured time.

In some embodiments, determining that the proof mass has reached the preset position includes measuring a voltage corresponding to a charge stored on the first electrode, and comparing the measured voltage to a predetermined voltage corresponding to the proof mass reaching the preset position. In some embodiments, measuring the time includes using a digital delay line circuit to measure a time between an edge of the first periodic voltage and a time at which the measured voltage equals the predetermined voltage. In some embodiments, measuring the voltage includes measuring the voltage using a charge amplifier. In some embodiments, the proof mass includes at least one layer of metal.

In some embodiments, the method includes periodically applying a second voltage to a second electrode positioned proximate to the proof mass. The second electrode may be positioned on a side of the proof mass opposite to the first electrode. The application of the second voltage may be synchronized with the application of the first periodic voltage to the first electrode. In some embodiments, the application of the second voltage generates an electrostatic force on the proof mass that fully offsets the electrostatic force generated by the application of the first periodic voltage. In some embodiments, the method includes determining the magnitudes of the first and second periodic voltages after manufacture of the accelerometer.

In some embodiments, measuring the time includes measuring the time by a digital delay line circuit. In some embodiments, the measured time ranges from around 1 picosecond to around 100 picoseconds. In some embodiments, the proof mass has a mass ranging from around 1 nanogram to around 100 nanograms. In some embodiments, the method includes automatically calibrating one or more parameters of the accelerometer to improve accuracy of a measurement provided by the accelerometer. In some embodiments, automatically calibrating one or more parameters of the accelerometer includes determining at least one of a resonant frequency, an effective resonant frequency, and a mechanical quality factor of the accelerometer.

In yet another aspect, the systems and methods described herein relate to a method for operating a MEMS accelerometer having a proof mass. The method includes periodically applying a first voltage to a first electrode positioned proximate to the proof mass. This applies an electrostatic force to the proof mass to draw the proof mass towards the first electrode. The method includes receiving an external acceleration at the accelerometer. The external acceleration may alter a time the proof mass takes to reach a preset speed in response to the applied voltage. The method includes determining that the proof mass has reached the preset speed. The method includes measuring a time taken for the proof mass to reach the preset speed. The method includes determining a magnitude and direction of the external acceleration based on the measured time.

In some embodiments, determining that the proof mass has reached the preset speed includes measuring a voltage corresponding to a current to the first electrode, and comparing the measured voltage to a predetermined voltage corresponding to the proof mass reaching the preset speed. In some embodiments, measuring the time includes using a digital delay line circuit to measure a time between an edge of the first periodic voltage and a time at which the measured voltage equals the predetermined voltage. In some embodiments, measuring the voltage comprises measuring the voltage using a current to voltage converter.

In some embodiments, the method includes periodically applying a second voltage to a second electrode positioned proximate to the proof mass. The second electrode may be positioned on a side of the proof mass opposite to the first electrode. The application of the second voltage may be synchronized with the application of the first periodic voltage to the first electrode. In some embodiments, the application of the second voltage generates an electrostatic force on the proof mass that fully offsets the electrostatic force generated by the application of the first periodic voltage. In some embodiments, the method includes determining the magnitudes of the first and second periodic voltages after manufacture of the accelerometer.

In some embodiments, measuring the time includes measuring the time by a digital delay line circuit. In some embodiments, the measured time ranges from around 1 picosecond to around 100 picoseconds. In some embodiments, the proof mass has a mass ranging from around 1 nanogram to around 100 nanograms. In some embodiments, the method includes automatically calibrating one or more parameters of the accelerometer to improve accuracy of a measurement provided by the accelerometer. In some embodiments, automatically calibrating one or more parameters of the accelerometer includes determining at least one of a resonant frequency, an effective resonant frequency, and a mechanical quality factor of the accelerometer.

In yet another aspect, the systems and methods described herein relate to an apparatus for analyzing acceleration of a proof mass of a MEMS accelerometer having a proof mass. The apparatus includes a first voltage source for periodically applying a first voltage to a first electrode positioned proximate to the proof mass. This applies an electrostatic force to the proof mass to draw the proof mass towards the first electrode. The apparatus includes a first comparator for comparing a voltage corresponding to the speed of the proof mass to a predetermined voltage to determine that the proof mass has reached a preset speed. The apparatus includes a digital delay line circuit for measuring a time taken for the proof mass to reach the preset speed. The apparatus includes a processor for determining a magnitude and direction of an external acceleration applied to the accelerometer based on the measured time.

In yet another aspect, the systems and methods described herein relate to an apparatus for analyzing acceleration of a proof mass of a MEMS accelerometer having a proof mass. The apparatus includes a first voltage source for periodically applying a first voltage to a first electrode positioned proximate to the proof mass. This applies an electrostatic force to the proof mass to draw the proof mass towards the first electrode. The apparatus includes a first comparator for comparing a voltage corresponding to the position of the proof mass to a predetermined voltage to determine that the proof mass has reached a preset position. The apparatus includes a digital delay line circuit for measuring a time taken for the proof mass to reach the preset position. The apparatus includes a processor for determining a magnitude and direction of an external acceleration applied to the accelerometer based on the measured time.

In yet another aspect, the systems and methods described herein relate to a method for operating a MEMS accelerometer having a proof mass. The method includes applying a first periodic voltage to a first electrode positioned proximate to the proof mass. This applies an electrostatic force that induces vibration of the proof mass at a first resonant frequency, and subsequently displaces the proof mass by a first displacement. The method includes applying a second voltage to the first electrode positioned proximate to the proof mass. This applies an electrostatic force that induces vibration of the proof mass at a second resonant frequency, and subsequently displaces the proof mass by a second displacement. The method includes applying a third voltage to the first electrode positioned proximate to the proof mass. This applies an electrostatic force that induces vibration of the proof mass at a third resonant frequency, and subsequently displaces the proof mass by a third displacement. The third periodic voltage is a multiple of the second periodic voltage. The method includes determining an offset relating to a rest position for the proof mass based on the applied periodic voltages, the resonant frequencies, and the displacements.

In some embodiments, the method includes applying the first voltage to the first electrode positioned proximate to the proof mass. The method includes receiving an external acceleration at the accelerometer. The external acceleration may alter displacement of the proof mass to a new displacement. The method includes determining the new displacement of the proof mass, and determining a magnitude of the external acceleration based on the first resonant frequency, the determined offset, and the new displacement.

### BRIEF DESCRIPTION OF THE DRAWINGS

Other advantages and characteristics of the systems and methods described herein may be appreciated from the following description, which provides a non-limiting description of illustrative embodiments, with reference to the accompanying drawings, in which:

FIG. 1A depicts a perspective view of an accelerometer, according to an illustrative embodiment of the invention;

FIG. 1B depicts a cross-section of an accelerometer, according to an illustrative embodiment of the invention;

FIG. 2 depicts a perspective view of a proof mass suitable for use in the accelerometer of FIGS. 1A and 1B, according to an illustrative embodiment of the invention;

FIG. 3A depicts a cross-section of an accelerometer along with a corresponding circuit diagram for measuring acceleration, according to an illustrative embodiment of the invention;

FIG. 3B depicts a cross-section of an accelerometer along with a corresponding circuit diagram for measuring acceleration, according to another illustrative embodiment of the invention;

FIG. 3C depicts a cross-section of an accelerometer along with a corresponding circuit diagram for measuring acceleration, according to yet another illustrative embodiment of the invention;

FIG. 4 depicts a flow diagram for operating an accelerometer, according to an illustrative embodiment of the invention;

FIG. 5A depicts a cross-section after a first set of process flow steps for fabricating an accelerometer, according to an illustrative embodiment of the invention;

FIG. 5B depicts a cross-section after a second set of process flow steps for fabricating an accelerometer, according to an illustrative embodiment of the invention;

FIG. 5C depicts a cross-section after a third set of process flow steps for fabricating an accelerometer, according to an illustrative embodiment of the invention;

FIG. 6 depicts a cross-section of an accelerometer having an alternative embodiment of a proof mass, according to an illustrative embodiment of the invention;

FIG. 7A depicts a cross-section of an accelerometer having its proof mass in a rest position, according to an illustrative embodiment of the invention;

FIG. 7B depicts a cross-section of an accelerometer having its proof mass in a first preset position, according to an illustrative embodiment of the invention;

FIG. 7C depicts a cross-section of an accelerometer having its proof mass in a second preset position, according to an illustrative embodiment of the invention.

### DETAILED DESCRIPTION OF EMBODIMENTS

To provide an overall understanding of the systems and methods described herein, certain illustrative embodiments will now be described. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

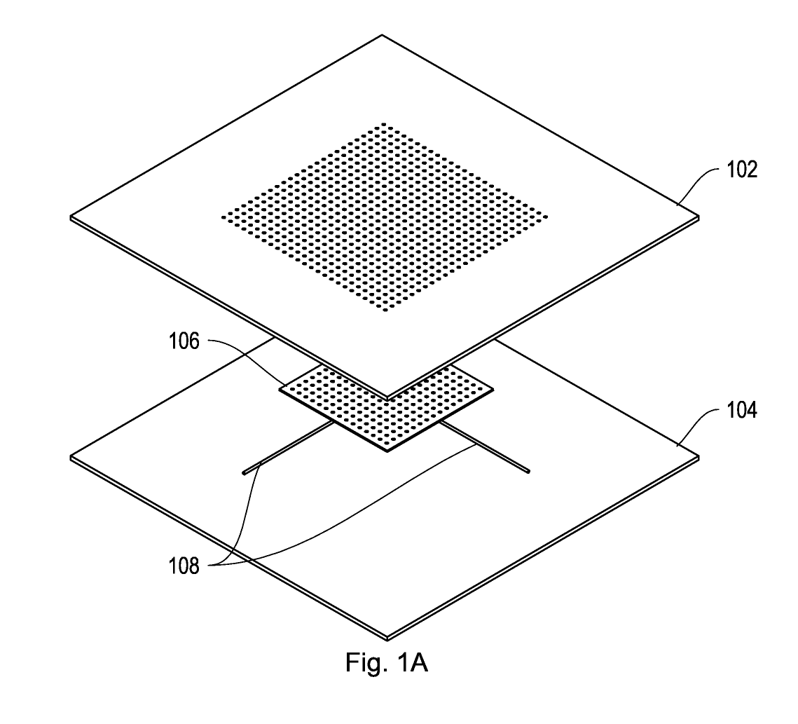

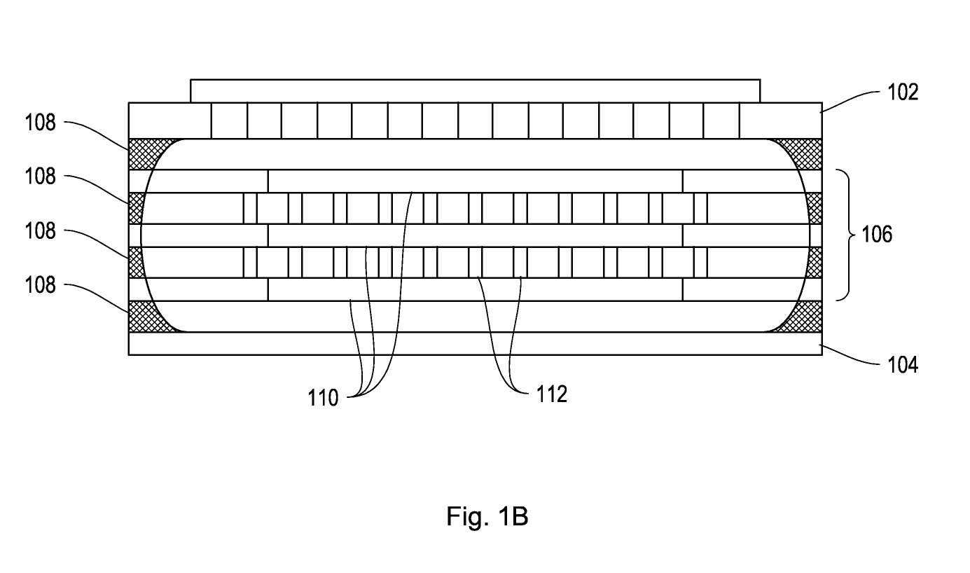

FIGS. 1A and 1B depict a perspective view and a cross-section, respectively, of accelerometer 100, according to illustrative embodiments of the invention. Accelerometer 100 includes top electrode 102, proof mass 106 below the top electrode, and bottom electrode 104 below proof mass 106. Proof mass 106 is suspended below top electrode 102 and above bottom electrode 104. In one embodiment, the distance between proof mass 106 and either electrode 102 or 104 ranges from around 0.3 um to around 0.7 um. Proof mass 106 includes three moveable metal plates 110 integrally formed with springs 108. Moveable plates 110 are made from stacked metal layers and are joined together via metal spacers or vias 112. In one embodiment, the metal layers are composed of material used in a standard CMOS process, e.g., an AlCu alloy. In one embodiment, moveable plates 110 have diameters of about 60 um. In other embodiments, moveable plates 110 have diameters ranging from about 50 um to about 100 um. Springs 108 restrict movement of proof mass 106 in one or more directions yet allow for movement of proof mass 106 in another direction. For example, springs 108 can restrict movement of proof mass 106 in the x and y directions and allow for movement of proof mass 106 in the z direction. Accelerometer 100 further includes a processor for operating the accelerometer. The processor controls one or more voltage sources that apply a voltage on either or both electrodes 102 and 104 to induce electrostatic forces on proof mass 106, determines a direction and a magnitude of an external acceleration, and performs other suitable functions for operating the accelerometer including controlling an auto-calibration process. In one embodiment, accelerometer 100 is fabricated in a cavity formed within interconnection layers of a CMOS chip. The walls of the cavity are made of oxide, and one end of springs 108 is integrally formed with moveable plates 110 of proof mass 106 while the other end is buried in the oxide to provide support to proof mass 106. Such an accelerometer can be fabricated using the nanoEMS™ process described in commonly-owned U.S. Patent Application Publication No. 2010/0295138, entitled “Methods and Systems for Fabrication of MEMS CMOS Devices”, and hereby incorporated by reference in its entirety.

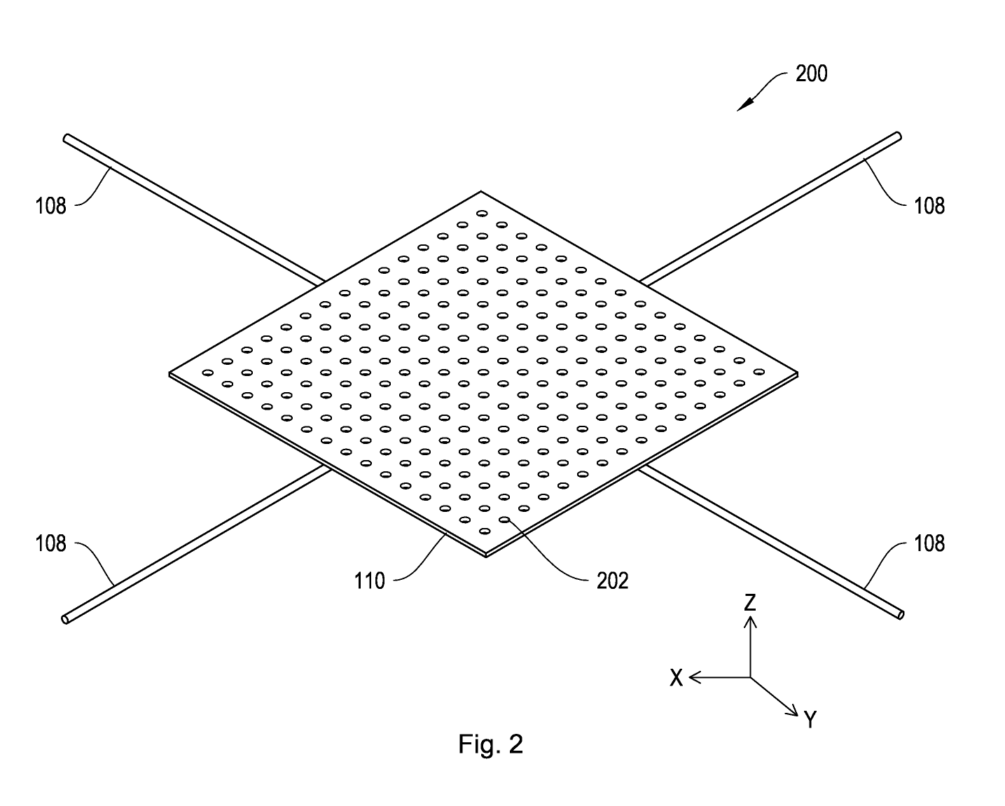

FIG. 2 depicts a perspective view of proof mass 200 suitable for use in the accelerometer of FIGS. 1A and 1B, according to an illustrative embodiment of the invention. Proof mass 200 is similar to proof mass 106 described with reference to FIGS. 1A and 1B. Proof mass 200 includes three moveable metal plates 110 integrally formed with springs 108. Moveable plates 110 have through-holes 202 to reduce air pressure that might otherwise hinder their movement. Through-holes 202 can allow passage of etchant during fabrication, e.g., vapor HF, to etch material below moveable plates 110. Through-holes 202 can also be used for positioning other mechanical features such as spacers. Springs 108 allow for out-of-plane movement of moveable plates 110 (e.g., z axis), while movement in other directions (e.g., x and y axes) is restricted due to stiffness of springs 108. Springs 108 can be formed to have more complex structures, e.g., a serpentine shape, an S-shape, a zig-zag shape, or any other suitable spring shape. In one embodiment, proof mass 200 includes a moveable plate and springs made from one metal layer composed of material used in standard CMOS process.

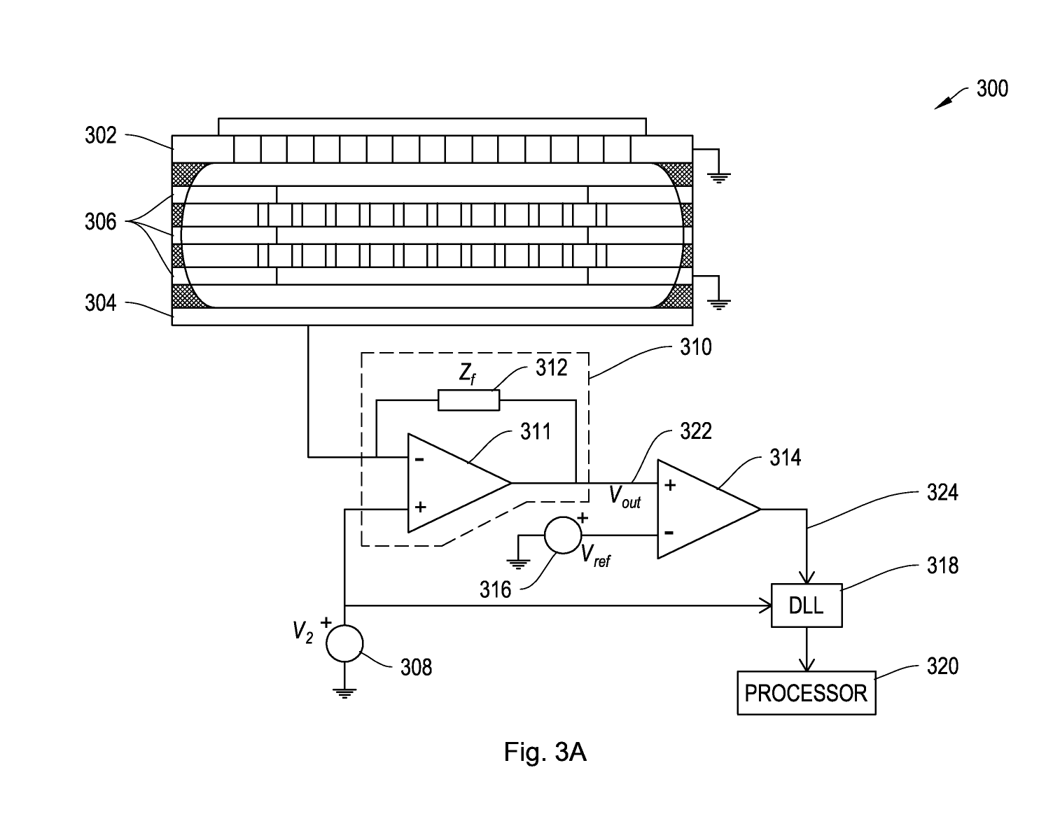

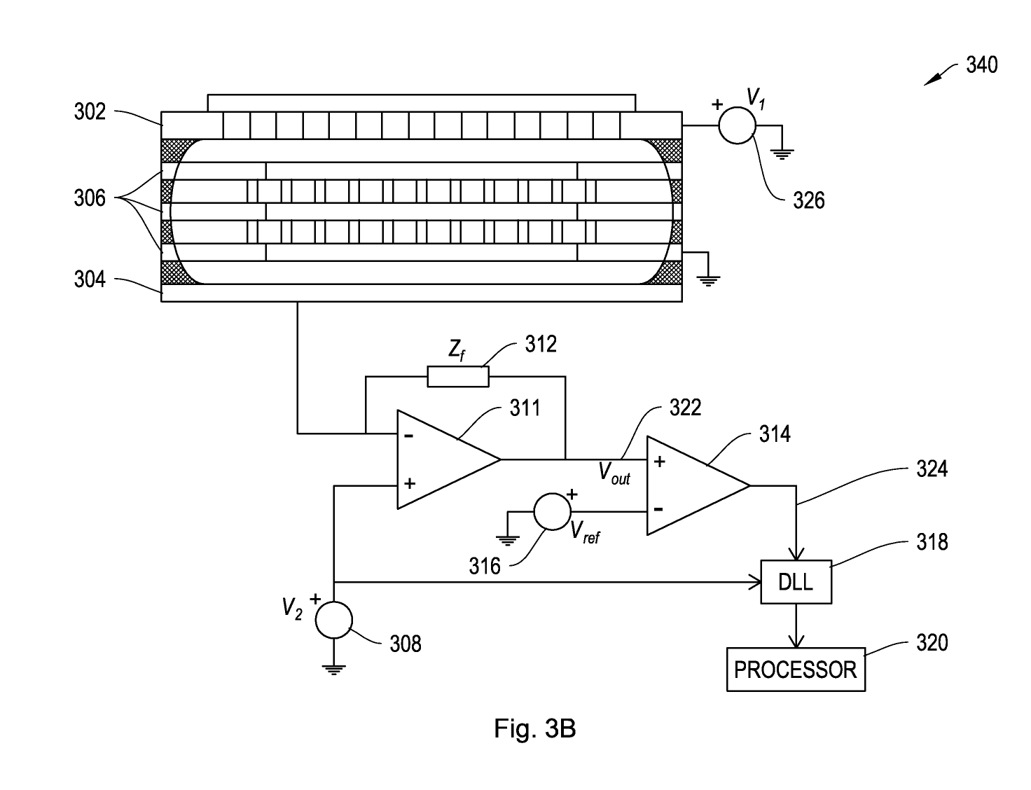

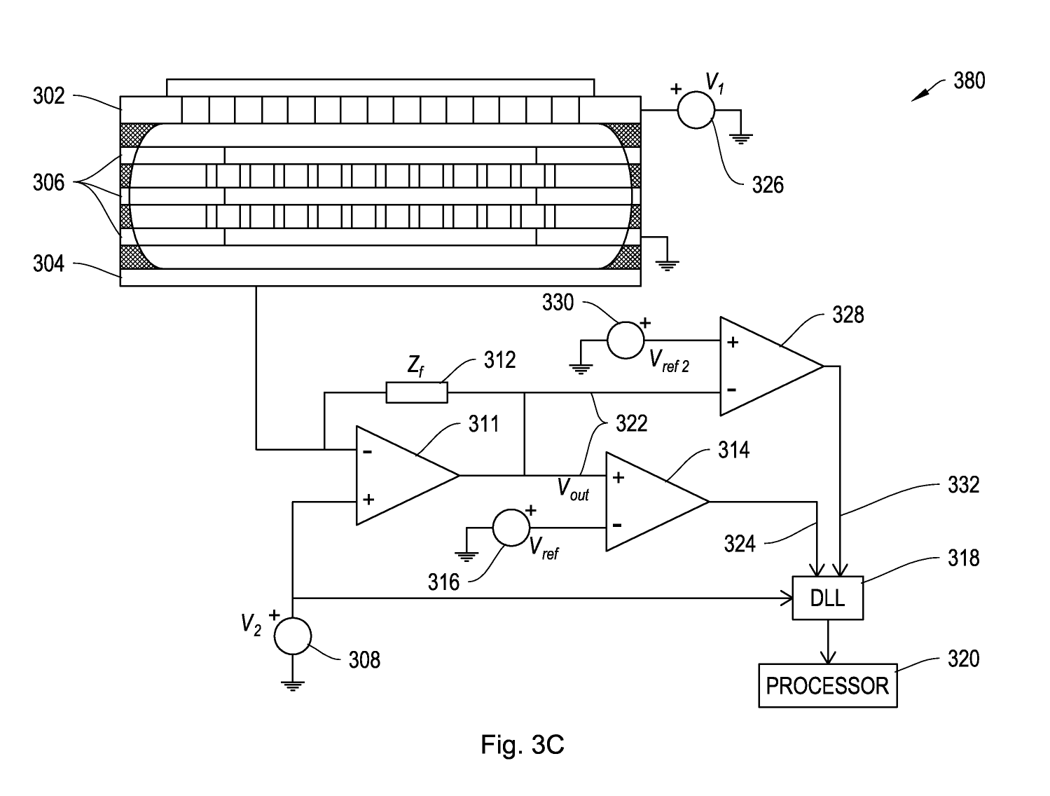

FIG. 3A depicts a cross-section of an accelerometer as described in FIGS. 1A and 1B along with a corresponding circuit diagram for measuring acceleration, according to an illustrative embodiment of the invention. The accelerometer includes top electrode 302 and bottom electrode 304 having proof mass 306 disposed therebetween. Proof mass 306 is similar to proof mass 106 described with reference to FIGS. 1A and 1B. Top electrode 302 and proof mass 306 are connected to ground. Bottom electrode 304 is connected to a voltage source 308. Bottom electrode 304 is also connected to charge amplifier 310 having operational amplifier 311 and capacitor 312. The charge amplifier is a charge-to-voltage converter and outputs a voltage proportional to the capacitance between the bottom electrode 304 and proof mass 306. The output voltage 322 of the charge amplifier is connected to a comparator 314 that compares output voltage 322 with reference voltage 316. Output 324 of comparator 314 is delivered to a digital delay line or delay-locked loop (DLL) circuit 318. DLL circuit 318 is also connected to voltage source 308, which is connected to bottom electrode 304. DLL circuit 318 is in communication with processor 320. Processor 320 contains logic to calculate a direction and a magnitude of external acceleration received at the accelerometer. In one embodiment, processor 320 is or includes an Application-Specific Integrated Circuit (ASIC), a Field Programmable Gate Array (FPGA), a Digital Signal Processor (DSP), or suitable digital logic. In one embodiment, processor 320 includes a memory having one or more of a register, a Random Access Memory (RAM), a Read-Only Memory (ROM), a Programmable Read-Only Memory (PROM), or a Flash memory. An embodiment of a suitable DLL circuit 318 is described in Michalik et al., 2010, Technology-portable mixed-signal sensing architecture for CMOS-integrated z-axis surface-micromachined accelerometers, Mixed Design of Integrated Circuits and Systems (MIXDES), 2010 Proceedings of the 17th International Conference, 2010:431-435, the entire contents of which are hereby incorporated by reference.

During operation of the accelerometer, a periodic voltage, e.g., a square voltage, is supplied by voltage source 308 to bottom electrode 304 and DLL circuit 318. In one embodiment, the voltage is equal to or larger than a pull-in voltage of the accelerometer, and ranges in the amplitude of the periodic voltage ranges from around 2V to around 24V. In one embodiment, the frequency of the periodic voltage is less than a resonant frequency of the accelerometer, and ranges from 10 kHz to 100 kHz. The supplied voltage creates an electric field and associated electromotive force across bottom electrode 304 and proof mass 306, drawing proof mass 306 towards bottom electrode 304. The supplied voltage also initiates DLL circuit 318 to start measuring a time period. DLL circuit 318 may be initiated at a rising edge or a falling edge of the supplied periodic voltage. Charge amplifier 310 outputs voltage 322 proportional to the changing capacitance resulting from movement of proof mass 306 towards bottom electrode 304. Comparator 314 compares output voltage 322 with reference voltage 316, and generates output 324 to DLL circuit 318. Output 324 is a high voltage if output voltage 322 is greater than reference voltage 316. Output 324 is a low voltage if output 322 is less than reference voltage 316. For example, output 324 is a positive voltage if output voltage 322 is greater than reference voltage 316, and a negative voltage if output 322 is less than reference voltage 316. When DLL circuit 318 receives a high voltage for output 324, i.e., output voltage 322 greater than reference voltage 316, DLL circuit 318 terminates measurement of the time period, and forwards the measurement to processor 320. Processor 320 calculates acceleration experienced by the accelerometer based on the time measurement. The periodic voltage supplied by voltage source 308 causes movement of proof mass 306 (e.g., on a rising edge), and allows proof mass 306 to return to its rest position (e.g., on a falling edge). Reversing the voltage applied to bottom electrode 304 periodically helps prevent excess charge build-up on the electrode, and helps maintain measurement accuracy and reliability of the accelerometer.

Reference voltage 316 corresponds to a preset position for proof mass 306. This calibration is performed at manufacture of the accelerometer. Alternatively, the calibration can be performed automatically during operation of the accelerometer, details for which are provided later in the disclosure. When comparator 314 determines that output voltage 322 is greater than reference voltage 316, proof mass 306 has passed the preset position. The displacement of proof mass 306 to reach the preset position is retrieved from memory of processor 320. In one embodiment, the preset position is around 10% of the distance between proof mass 306 and bottom electrode 304 from the rest position of proof mass 306. In one embodiment, the preset position ranges from around 50 nm to around 200 nm from the rest position of proof mass 306. Processor 320 also receives from DLL circuit 318 a measurement of time taken by proof mass 306 to reach the preset position. Processor 320 calculates a magnitude of acceleration experienced by the accelerometer based on the displacement and the time measurement according to the following:

a=2*x/t² (1)
where, x is the displacement, and
   t is the time measurement

Furthermore, processor 320 calculates a direction of the acceleration. Assuming no external acceleration, proof mass 306 takes a certain period of time to reach the preset position. This period of time can be termed as the threshold time period. If the time measurement provided by DLL circuit 318 is higher than the threshold time period, then the direction of acceleration is away from the top electrode and towards the bottom electrode. Alternatively, if the time measurement is lower than the threshold time period, then the direction of acceleration is away from the bottom electrode and towards the top electrode.

In one embodiment, processor 320 determines acceleration experienced by the accelerometer based on the time measurement by retrieving an acceleration value corresponding to the time measurement from a look-up table. Further details for this embodiment are described later in the disclosure with respect to an autocalibration process.

In one embodiment, processor 320 calculates displacement of proof mass 306 based on capacitance resulting from movement of proof mass 306. Charge amplifier 310 outputs voltage 322 proportional to the changing capacitance resulting from movement of proof mass 306 towards bottom electrode 304. Processor 320 calculates proportionality factor

$$( \frac{{C}_{0}}{g} ) ,$$

which is described later in the disclosure. The displacement of proof mass 306 and the changing capacitance are then related according to the following:

$$C \approx {C}_{0} + ( \frac{{C}_{0}}{g} ) x$$

Once the relationship between the changing capacitance and the displacement are known, the capacitance corresponding to a displacement can be determined. For example, the capacitance corresponding to the displacement for the preset position is determined. Reference voltage 316 corresponding to the preset position is set based on the corresponding capacitance.

In an alternative embodiment, reference voltage 316 corresponds to a preset speed for proof mass 306. Instead of charge amplifier 310, a current amplifier is provided. The current amplifier includes operational amplifier 311 connected to a resistor (instead of capacitor 312) in a similar configuration. The current amplifier is a current-to-voltage converter and outputs voltage 322 proportional to the current sensed at the bottom electrode 304. When comparator 314 determines that output voltage 322 is greater than reference voltage 316, proof mass 306 has passed the preset speed. The time measurement for proof mass 306 to reach the preset speed is provided to processor 320 by DLL circuit 318. As such, processor 320 calculates acceleration experienced by the accelerometer based on the preset speed and the time measurement according to the following:

a=v/t (2)
where, v is the speed, and
t is the time measurement

In one embodiment, processor 320 calculates speed of proof mass 306 based on current sensed at the bottom electrode 304. The current amplifier outputs voltage 322 proportional to the current i_{C} sensed at the bottom electrode 304, which is proportional to the speed of proof mass 306, \dot{x}, as described below:

$${i}_{C} = {V}_{P} \frac{d C}{d t} \approx {V}_{p} ( \frac{{C}_{0}}{g} ) \dot{x} \qquad ( 14 )$$

where, Vₚ is the voltage applied at bottom electrode 304,
C₀ is the capacitance between proof mass 306 and bottom electrode 304,
g is the distance between proof mass 306 and bottom electrode 304
   In order to determine the speed \dot{x} of proof mass 306, processor 302 calculates the proportionality constant

$$( \frac{{C}_{0}}{g} ) .$$

In one embodiment, processor 302 controls a voltage source to apply a current through bottom electrode 304 for generating a local magnetic field \vec{B}_{cal} orthogonal to the direction of movement of proof mass 306, and receives a measurement for voltage v_{L} generated across proof mass 306 in a direction orthogonal to both the magnetic field and the direction of movement. Using the Lorentz Force equation, speed \dot{x} for proof mass 306 is calculated from:

v_{L}=(B_{cal}·l)\dot{x} (15)

where l is the length of proof mass 306, and (B_{cal}·l) is a design parameter. Relative variation of value (B_{cal}·l) due to process tolerances and temperature variations is expected to be small, and therefore, can be considered approximately constant for the operation of the accelerometer.

Given speed \dot{x} for proof mass 306, the proportionality factor

$$( \frac{{C}_{0}}{g} )$$

can be calculated using equation (14). Local magnetic field \vec{B}_{cal} can be turned on periodically to calculate the proportionality factor, and then turned off. The proportionality factor is then used to calculate the speed \dot{x} for proof mass 306. The threshold current i_{C max} that needs to be detected by the current amplifier can be calculated based on the proportionality factor. In one embodiment, threshold current i_{C max} is kept constant while processor 302 calculates variable

$$( \frac{{C}_{0}}{g} )$$

to determine speed \dot{x} for proof mass 306, and consequently, the acceleration experienced by proof mass 306.

FIG. 3B is an alternative embodiment of an accelerometer and corresponding circuitry that includes DLL circuit 318 with lower resolution. In such an embodiment, absent any damping, the time taken for proof mass 306 to travel to the preset position may be smaller than the resolution of DLL circuit 318. To resolve this issue, the movement of proof mass 306 is damped by connecting top electrode 302 to a voltage source instead of ground. This approach is beneficial for an accelerometer having a small proof mass, e.g., ranging from, but not limited to, around 0.1 nanogram to around 100 nanograms. Similar to FIG. 3A, the accelerometer includes top electrode 302 and bottom electrode 304 having proof mass 306 disposed therebetween. However, top electrode 302 is connected to voltage source 326. The remaining connections are configured similar to FIG. 3A. Proof mass 306 is connected to ground. Bottom electrode 304 is connected to voltage source 308. Bottom electrode 304 is also connected to charge amplifier 310 having operational amplifier 311 and capacitor 312. The output voltage 322 of the charge amplifier is connected to a comparator 314 that compares output voltage 322 with reference voltage 316. Output 324 of comparator 314 is delivered to a delay-locked loop (DLL) circuit 318. DLL circuit 318 is also connected to voltage source 308, which is connected to bottom electrode 304. DLL circuit 318 is in communication with processor 320.

During operation of the accelerometer, a periodic voltage, e.g., a square voltage, is supplied by voltage source 308 to bottom electrode 304 and DLL circuit 318. Another periodic voltage synchronized with voltage source 318 is supplied by voltage source 326. However, voltage source 326 supplies a voltage having a different magnitude than voltage source 318. The supplied voltages create respective electric fields and associated electromotive forces across bottom electrode 304 and proof mass 306, and across top electrode 302 and proof mass 306, respectively. The supplied voltage from voltage source 318 also initiates DLL circuit 318 to start measuring a time period. The required resolution or sensitivity of DLL circuit 318 is reduced (compared to the DLL circuit in FIG. 3A) because the voltage supplied to top electrode 302 damps movement of proof mass 306. In a non-limiting example, DLL circuit 318 may have a time resolution ranging from around 10 ns to around 100 ns, while the DLL circuit in FIG. 3A may have a time resolution ranging from around 10 ps to around 100 ps. Charge amplifier 310 outputs voltage 322 proportional to the changing capacitance resulting from movement of proof mass 306 with respect to bottom electrode 304. Comparator 314 compares output voltage 322 with reference voltage 316, and generates output 324 to DLL circuit 318. Output 324 is a high voltage if output voltage 322 is greater than reference voltage 316. Output 324 is a low voltage if output 322 is less than reference voltage 316. When DLL circuit 318 receives a high voltage for output 324, i.e., output voltage 322 greater than reference voltage 316, DLL circuit 318 terminates measurement of the time period, and forwards the measurement to processor 320. The time measurement for proof mass 306 to reach the preset position is provided to processor 320 by DLL circuit 318, and processor 320 calculates acceleration experienced by the accelerometer based on the preset position and the time measurement.

FIG. 3C is an alternative embodiment of an accelerometer and corresponding circuitry where the periodic voltages supplied by voltage source 308 and voltage source 326 are synchronized and have magnitudes such that their respective effects on proof mass 306 are fully offset. This can be termed as electrostatic softening. Proof mass 306 is placed in an unstable equilibrium. In such a case, proof mass 306 moves primarily due an external acceleration, while there is minimal movement of proof mass 306 due to the supplied voltages. Similar to FIG. 3A, the supplied voltage from voltage source 308 initiates DLL circuit 318 to start measuring a time period. However, charge amplifier 310 provides output voltage 322 to comparators 314 and 328 that determine whether proof mass 306 has reached either a first or a second preset position. The first preset position corresponds to acceleration of proof mass 306 such that it moves towards bottom electrode 306. This first preset position corresponds to reference voltage 316. The second preset position corresponds to acceleration of proof mass 306 such that it moves towards top electrode 302. This second preset position corresponds to reference voltage 330. DLL circuit 318 receives respective outputs 324 and 332 from comparators 314 and 328, and terminates measurement of the time period when either output voltage 322 is higher than reference voltage 316 or lower than reference voltage 330. DLL circuit 318 provides the time measurement for proof mass 306 to reach the respective preset position to processor 320. Processor 320 receives outputs 324 and 332 from comparators 314 and 328 and determines whether proof mass 306 has reached the first or the second preset position. The displacement of proof mass 306 to reach the respective position is retrieved from memory of processor 320. Processor 320 calculates acceleration experienced by the accelerometer based on the respective preset position and the time measurement. In an alternate embodiment, a portion of the measurement circuitry is replicated such that a second charge amplifier, comparator 328, and reference voltage 330 are connected to top electrode 302. Charge amplifier 310 need only provide output voltage 322 to comparator 314 to determine whether proof mass 306 has reached the first preset position, while the second charge amplifier provides an output voltage to comparator 328 to determine whether proof mass 306 has reached the second preset position. However, replicating the measurement circuitry can add to the cost and die area for fabricating the accelerometer, as well as increase the power consumption of the accelerometer.

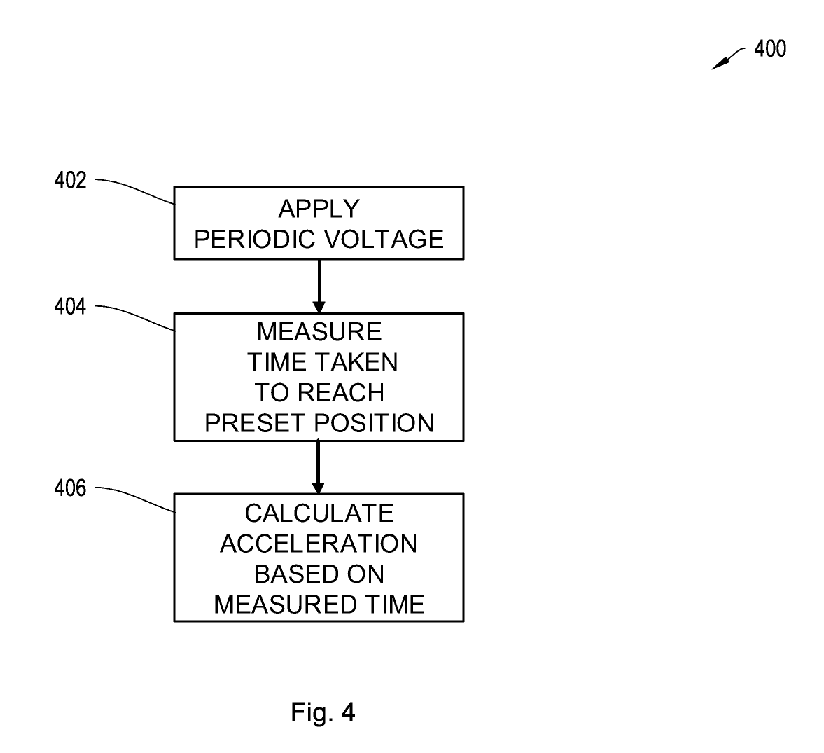

To summarize the operation of an accelerometer as described with reference to FIGS. 3A-3C, FIG. 4 depicts a flow diagram for operating an accelerometer, according to an illustrative embodiment. At step 402, control circuitry of an accelerometer applies a periodic voltage, e.g., a square voltage, to a bottom electrode of the accelerometer and a delay-locked loop (DLL) circuit in communication with the accelerometer. The supplied voltage creates an electric field and associated electromotive force across the bottom electrode and a proof mass, drawing the proof mass towards the bottom electrode. The supplied voltage also initiates the DLL circuit to start measuring a time period. In an alternative embodiment, periodic voltages that are synchronized and having different magnitudes are applied to the top and bottom electrodes of the accelerometer. In another embodiment, periodic voltages that are synchronized and having magnitudes such that their respective effects on the proof mass are fully offset are applied to the top and bottom electrodes of the accelerometer. Further details describing how to determine such voltages whose respective effects on the proof mass are fully offset are provided further below.

At step 404, control circuitry of the accelerometer determines when the proof mass has reached a preset position. With the aid of a charge amplifier, the control circuitry outputs a voltage proportional to the changing capacitance resulting from movement of the proof mass towards the bottom electrode. The control circuitry then compares the voltage to a reference voltage, which indicates that the proof mass has reached the preset position. When the control circuitry receives indication that the proof mass has reached the preset position, the control circuitry terminates measurement of the time period by the DLL circuit, and forwards the measurement to a processor. The displacement of the proof mass to reach the preset position is retrieved from memory of the processor. Alternatively, the control circuitry determines whether the proof mass has reached a preset speed with the aid of a current amplifier, and forwards to the processor a time measurement for the proof mass to reach the preset speed.

At step 406, the processor calculates acceleration experienced by the accelerometer based on the displacement and the time measurement. Alternatively, the processor receives a speed and a time measurement and calculates acceleration experienced by the accelerometer based on the speed and the time measurement.

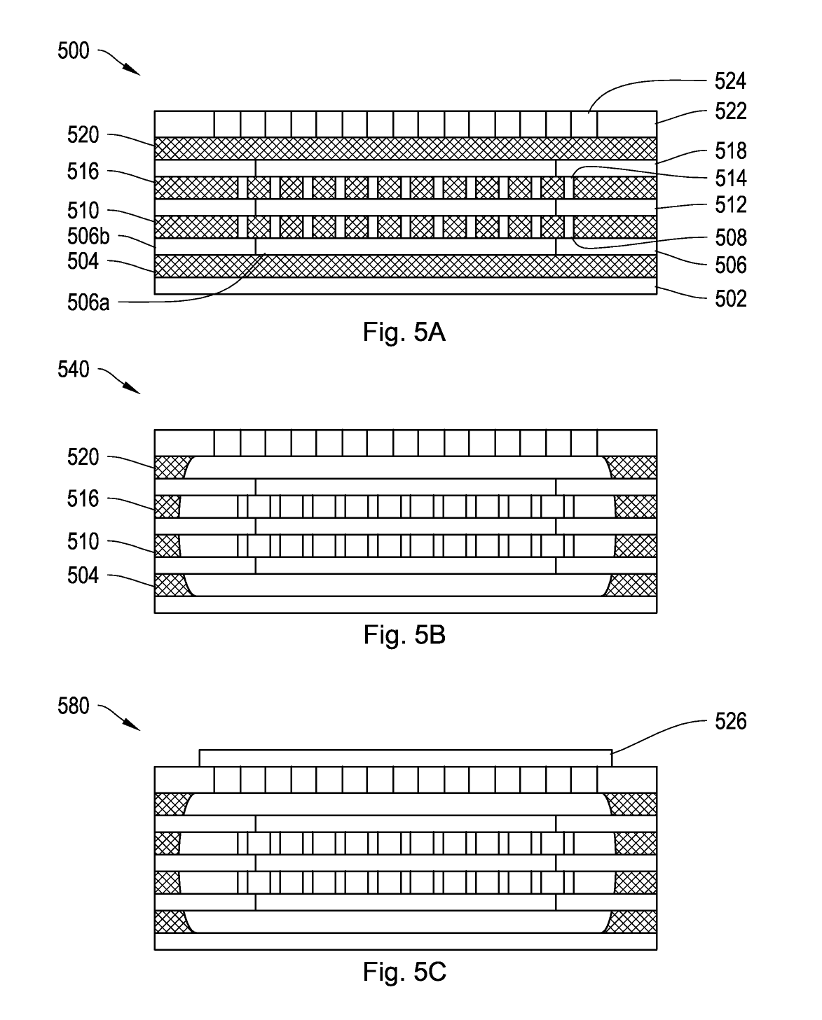

We now describe process flow steps for fabricating an accelerometer that is operated as described with respect to FIG. 4. FIG. 5A depicts a cross-section after a first set of process flow steps for fabricating the accelerometer, according to an illustrative embodiment of the invention. The thickness of the layers has been magnified. In one embodiment, the accelerometer is fabricated using a standard CMOS process. In one embodiment, the accelerometer is fabricated in a cavity formed within interconnection layers of a CMOS chip. In an alternative embodiment, the accelerometer is fabricated as a stand-alone MEMS device. Initially a metal layer for bottom electrode 502 is deposited. The metal layer can be made from, e.g., AlCu metal alloy. Above bottom electrode 502, an Inter Metal Dielectric (IMD) layer 504 is deposited. In one embodiment, the IMD layer includes a layer of non-doped oxide. Above IMD layer 504, metal layer 506 for the proof mass is deposited. A masking layer is deposited above metal layer 506, and then metal layer 506 is etched using, e.g., dry HF, to form moveable plate 506a and springs 506b. Another IMD layer 510 is deposited on metal layer 506, followed by a masking layer, and then the IMD layer is etched and filled with metal to form spacers or vias 508. The process performed on metal layer 506 is repeated for metal layers 512 and 518 to form more moveable plates integrally formed with springs for the proof mass. The process performed on IMD layer 510 is repeated for IMD layer 516 to form vias 514. In the embodiment shown, the proof mass includes three moveable plates along with integrally formed springs. Another IMD layer 520 is deposited on metal layer 518, followed by metal layer 522 for the top electrode. A masking layer is deposited on metal layer 522. Metal layer 522 is then etched to form through-holes 524. The through-holes can also allow passage of etchant, e.g., vapor HF, to etch material below metal layer 522.

FIGS. 5B and 5C depict cross-sections after a second and a third set of process flow steps, respectively, for fabricating the accelerometer, according to illustrative embodiments of the invention. An etchant, e.g., dry HF, is released via through-holes 524 in top electrode 522. The etchant etches away portions of IMD layers 504, 510, 516, and 520 to release the moveable plates and springs for the proof mass, as shown in FIG. 5B. One end of the springs extends from the moveable plates of the proof mass, while the other end is buried in the remaining oxide of IMD layers 504, 510, 516, and 520 left to form cavity walls to provide support to the proof mass. Finally, metallization layer 526 is deposited on top electrode 522 to seal the accelerometer from the outside environment, as shown in FIG. 5C. In one embodiment, the accelerometer is fabricated using MEMS-based, NEMS-based, or MEMS CMOS-based integrated chip technology.

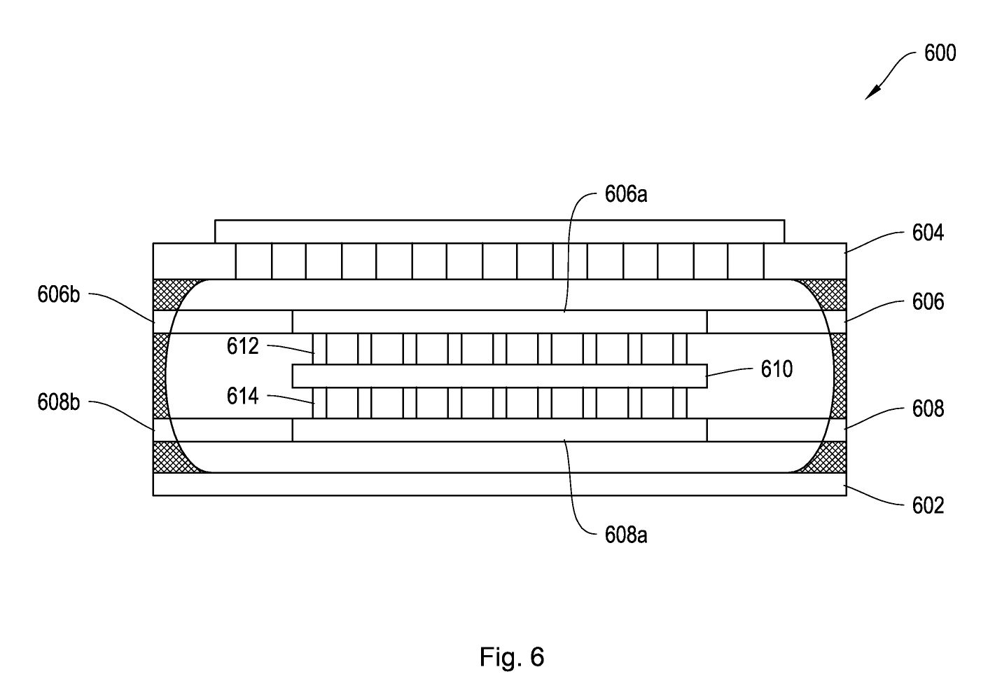

FIG. 6 depicts a cross-section of an accelerometer having an alternative embodiment of a proof mass, according to an illustrative embodiment of the invention. The accelerometer includes bottom electrode 602 and top electrode 604. The proof mass includes three metal layers 606, 608, and 610. However, only metal layers 606 and 608 include moveable plates 606a and 608a with integrally formed springs 606b and 608b, respectively. Metal layer 610 instead includes a moveable plate 610 only, which is attached to upper moveable plate 606a and lower moveable plate 608a with vias or spacers 612 and 614, respectively. There are no springs formed with moveable plate 610. Such an arrangement allows for a proof mass with lower stiffness due to reduction in number of springs. This arrangement can be fabricated by using an alternative masking layer that does not leave the springs in metal layer 610.

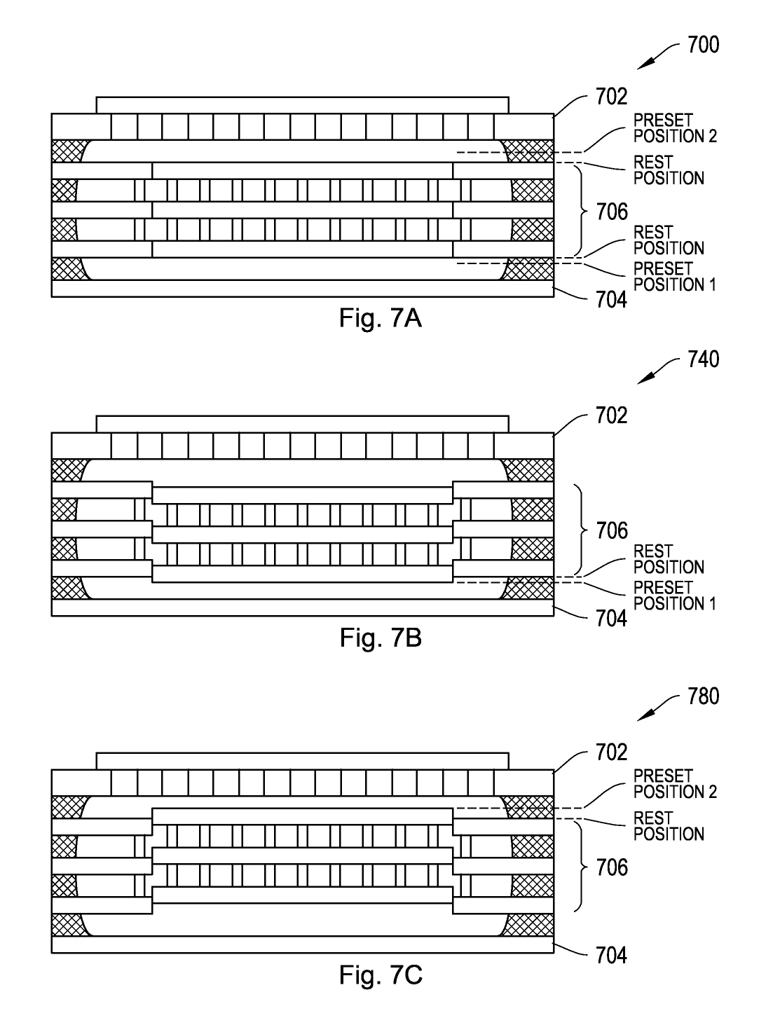

FIGS. 7A-7C depict cross-sections of an accelerometer having its proof mass in different positions, according to illustrative embodiments of the invention. The illustrated accelerometer corresponds to the accelerometer of FIG. 3C, in which periodic voltages are applied to the top and bottom electrodes. FIG. 7A shows the proof mass 706 in “rest position”, e.g., when there is no external acceleration. FIG. 7B shows movement of proof mass 706 towards bottom electrode 704, and particularly when it has reached “preset position 1”. FIG. 7C shows movement of proof mass 706 towards top electrode 702, and particularly when it has reached “preset position 2”. As discussed above, a processor in communication with the accelerometer calculates the acceleration based on the time taken for the proof mass to reach either preset position and the displacement of the proof mass from the rest position.

In one aspect, an autocalibration process is used to automatically and/or periodically calibrate the accelerometer to account for changes in component properties over time or due to process variations. One or more parameters of the accelerometer can be automatically calibrated to improve accuracy of a measurement provided by the accelerometer. In one embodiment, the parameters determined are a proportionality factor of applied voltages V₁ and V₂, a mechanical quality factor of the accelerometer, a resonant frequency of the accelerometer, and an effective resonant frequency of the accelerometer.

The proportionality factor of the applied voltages for an embodiment of the accelerometer where each voltage's respective effects on the proof mass are fully offset is set forth below. If there are no process variations during manufacture of the accelerometer, then simply voltages of equal magnitude can be used. However, if there are process variations, the voltages are determined as follows. Assume the top electrode is separated a distance g₁ from the proof mass, has an effective area A₁, and generates a capacitance C₁ with the proof mass. Assume the bottom electrode is separated a distance g₂ from the proof mass, has an effective area A₂, and generates a capacitance C₂ with the proof mass. The electrostatic force Fₑ generated by these two electrodes when voltages V₁ and V₂ are applied to them respectively, and when proof mass is displaced by a distance x, is calculated as:

$${F}_{e} = \frac{{ɛ}_{0}}{2} [ \frac{{V}_{1}^{2} {A}_{1}}{{( {g}_{1} - x )}^{2}} - \frac{{V}_{2}^{2} {A}_{2}}{{( {g}_{2} + x )}^{2}} ] \qquad ( 3 )$$

where, x is displacement of the proof mass, and
   ε₀ is the vacuum permittivity
      For small displacements x, this electrostatic force is approximated using the first two terms of the Taylor series expansion as:

$${F}_{e} = \frac{1}{2} ( \frac{{V}_{1}^{2} {C}_{1}}{{g}_{1}} - \frac{{V}_{2}^{2} {C}_{2}}{{g}_{2}} ) + ( \frac{{V}_{1}^{2} {C}_{1}}{{g}_{1}^{2}} + \frac{{V}_{2}^{2} {C}_{2}}{{g}_{2}^{2}} ) x , x << 1 \\ where , \\ {C}_{1} = {ɛ}_{0} \frac{{A}_{1}}{{g}_{1}} , {C}_{2} = {ɛ}_{0} \frac{{A}_{2}}{{g}_{2}} \qquad ( 4 )$$

The relationship between the voltages applied to the top and bottom electrodes respectively such that their effects on the proof mass are fully offset is calculated as:

$$\frac{{V}_{1}^{2} {C}_{1}}{{g}_{1}} = \frac{{V}_{2}^{2} {C}_{2 }}{{g}_{2}} \qquad ( 5 )$$

which is equivalent to:

$${V}_{2} = {V}_{1} \frac{{g}_{2}}{{g}_{1}} \sqrt{\frac{{A}_{1}}{{A}_{2}}} \qquad ( 6 )$$

If the electrodes of the accelerometer are symmetrical and the accelerometer has zero process variations (i.e., g₁=g₂ and A₁=A₂), the required voltages are the same (V₂=V₁). If there are process variations, the proportionality factor

$$\frac{{g}_{2}}{{g}_{1}} \sqrt{\frac{{A}_{1}}{{A}_{2}}}$$

needed in order to satisfy equation (6) can be determined by applying only voltage V₁ to the bottom electrode and then turning it off and applying voltage V₂ of equal value to the top electrode and turning it off. The time elapsed t₁ and t₂ in each case for the proof mass to reach the preset position is measured. Based on this data, the proportionality factor is calculated as:

$$\frac{{g}_{2}}{{g}_{1}} \sqrt{\frac{{A}_{1}}{{A}_{2}}} = {( \frac{{t}_{2}}{{t}_{1} } )}^{2} , \qquad ( 7 )$$

where g₁ is the distance of the top electrode from the proof mass,
g₂ is the distance of the bottom electrode from the proof mass,
   A₁ is the effective area of the top electrode,
   A₂ is the effective area of the bottom electrode, and
t₁ and t₂ are times elapsed for the proof mass to reach the preset position

The proportionality factor

$$\frac{{g}_{2}}{{g}_{1}} \sqrt{\frac{{A}_{1}}{{A}_{2}}}$$

is alternatively determined based on the current flowing the proof mass. Either voltage V₁ or V₂ is applied at a fixed value, and the other voltage is varied from a low voltage value to a high voltage value. As the voltage value is varied, the direction of the proof mass changes and the current flow through the proof mass is reversed. The voltage value where this change occurs is where the two electrostatic forces are made equal. The proportionality factor is then determined by inserting the fixed voltage value and the varied voltage value into equation (6), and the voltages V₁ or V₂ are set accordingly.

The mechanical quality factor Q of the accelerometer is a dimensionless parameter that describes how under-damped an oscillation is. When electrostatic forces are applied to the proof mass, and then disconnected, the proof mass resonates for a period of time before it reaches to a rest position. The mechanical quality factor Q can be measured by disconnecting the electrostatic forces and counting the number of cycles N that it takes for the proof mass to reach its rest position. The mechanical quality factor Q is then calculated as:

$$Q = \frac{2 π}{N} , \qquad ( 8 )$$

where, N is the number of cycles taken for the proof mass to reach its rest position
   If the electrostatic forces are not disconnected in a controlled way, the proof mass may experience large oscillations before returning to its rest position. For example, for a high mechanical quality factor Q, e.g., 1000, a large period of time is required to allow the proof mass to reach its resting position. This large period of time is provided each time an external acceleration is measured using the accelerometer. In one embodiment, the periodic voltages driving the electrostatic forces are turned off in a controlled way so that the proof mass reaches the rest position in a shorter period of time. In another embodiment, several accelerometers are implemented in parallel, and the control circuitry is multiplexed to work with one accelerometer at a given time, while allowing the other accelerometers to reach their respective rest positions. In yet another embodiment, the DLL circuit in communication with the accelerometer is adapted to monitor the duty cycle of a proof mass maintained in a substantially continuous movement. The applied periodic voltages cause periodic movement of the proof mass, which results in periodic triggering of the charge amplifier, and consequently the comparator, at the same frequency as the periodic voltages. However, the duty cycle of the comparator output depends on the external acceleration experienced by the accelerometer. This duty cycle can be measured along with the time period for the proof mass to reach the preset position using the adapted DLL circuit. The duty cycle and time period can be used to determine the external acceleration, without any interruption in the applied periodic voltages.

Next, we discuss how to determine the resonant frequency ω₀ and the effective resonant frequency ω_{0T} of the accelerometer. In this case, either voltage V₁ or V₂ is applied as an AC voltage. A range of frequency values is applied around an expected resonant frequency, and the frequency which produces a larger displacement of the proof mass is determined. In cases with a large mechanical quality factor, Q, the frequency resolution fᵣ of the range of frequency value is calculated as:

$${f}_{r} \leq \frac{{f}_{0}}{2 Q} \\ where , {f}_{0} = \frac{{ω}_{0}}{2 π} \qquad ( 9 )$$

The effective resonant frequency ω_{0T} is the resonant frequency when a voltage is applied to either electrode. This resonant frequency value is expected to be complex and cannot be measured directly for embodiments having an unstable equilibrium between the proof mass and electrodes of the accelerometer. However, the resonant frequency value can be measured for embodiments having a stable state as described above with reference to resonant frequency ω₀. Voltage V₁ is applied such that the proof mass and electrodes are in a stable state, typically a low voltage value, and parameter D is determined from the equation below:

$${ω}_{OT}^{2} ( {V}_{1} ) = {ω}_{0}^{2} - [ \frac{{C}_{1}}{{mg}_{1}} ( \frac{1}{{g}_{1}} + \frac{1}{{g}_{2}} ) ] {V}_{1}^{2} = {ω}_{0}^{2} - {DV}_{1}^{2} \\ where , \\ D = \frac{{C}_{1}}{{mg}_{1}} ( \frac{1}{{g}_{1}} + \frac{1}{{g}_{2}} ) , \qquad ( 10 )$$

ω₀ is the determined resonant frequency,
g₁ is the distance of the top electrode from the proof mass,
g₂ is the distance of the bottom electrode from the proof mass,
C₁ is the capacitance generated between the top electrode and the proof mass, and
V₁ is the voltage applied to the top electrode.
   The value of parameter D is constant for different values of V₁ and ω²_{0T}, and consequently, Ω_{0T} can be calculated using an applied voltage value V₁ and the determined value for parameter D in equation (10).

In one embodiment, a processor included in an accelerometer (e.g., processor 320 in FIGS. 3A-3C) determines acceleration experienced by the accelerometer based on the time measurement for the accelerometer's proof mass to reach a preset position or a preset speed, and autocalibrated parameter values for resonant frequency ω₀, effective resonant frequency ω_{0T}, and mechanical quality factor Q. The processor controls the voltages sources to apply a range of voltages V₁ or V₂ to the electrodes, and builds a look-up table in memory relating the autocalibrated parameters, the time measurement, and the acceleration. Once the look-up table is generated, the processor determines the acceleration experienced by the accelerometer by retrieving from a look-up table an acceleration value based on the time measurement and other autocalibrated parameter values.

In an alternative embodiment, a processor included in an accelerometer determines acceleration experienced by the accelerometer based on the displacement for the accelerometer's proof mass and autocalibrated parameter values for an operating voltage V₀ and resonant frequency ω₀. In one embodiment, voltage V₀ ranges from around 1V to around 2V. The acceleration a is calculated according to the following:

a=ω₀²x+x₀−B (11)

The offset x₀ corresponds to displacement of the proof mass at a rest position. In order to determine x₀, the processor controls a voltage source to apply a voltage V at one of the electrodes, and generate a new resonant frequency ω²_{0T}. However, applying this voltage V generates additional electrostatic force that affects the rest position of the proof mass. This adds another variable to the equation represented by term B in equation (11). In order to determine B, the processor controls the voltage source to apply another voltage nV, which is n times voltage V, and results in a new resonant frequency n²ω²_{0T}. Assuming the displacement of the proof mass to be x₁ at resonant frequency ω₀, x₂ at resonant frequency ω²_{0T}, and x₃ at resonant frequency n²ω²_{0T}, the offset x₀ and term B can be calculated from the following system of equations:

a=ω₀²(x₁−x₀)=ω_{0T}²(x₂−x₀)−B=n²ω_{0T}²(x₃−x₀)−n²B (12)

Once x₀ and B are known, the processor determines the acceleration experienced by the accelerometer using the displacement of the proof mass x and the resonant frequency ω₀ in equation (11). The displacement of the proof mass x can be determined with the aid of a charge amplifier as described with reference to FIGS. 3A-3C. The resonant frequency ω₀ is determined as described above.

Applicants consider all operable combinations of the embodiments disclosed herein to be patentable subject matter. Those skilled in the art will know or be able to ascertain using no more than routine experimentation, many equivalents to the embodiments and practices described herein. For example, though the accelerometer proof mass has been described as having out-of-plane movement (z direction), the embodiments and practices may be equally applicable to an accelerometer proof mass having in-plane movement (i.e., x and/or y directions). Accordingly, it will be understood that the systems and methods described herein are not to be limited to the embodiments disclosed herein, but is to be understood from the following claims, which are to be interpreted as broadly as allowed under the law. It should also be noted that, while the following claims are arranged in a particular way such that certain claims depend from other claims, either directly or indirectly, any of the following claims may depend from any other of the following claims, either directly or indirectly to realize any one of the various embodiments described herein.

1. A method for operating a MEMS accelerometer having a proof mass, comprising
periodically applying a first voltage to a first electrode positioned proximate to the proof mass, thereby applying an electrostatic force to the proof mass to draw the proof mass towards a preset position between a rest position and the first electrode;
receiving an external acceleration at the accelerometer, wherein the external acceleration alters a time the proof mass takes to reach the preset position in response to the applied voltage;
determining that the proof mass has reached the preset position;
measuring a time taken for the proof mass to reach the preset position;
determining a magnitude and direction of the external acceleration based on the measured time.

2. The method of claim 1, wherein determining that the proof mass has reached the preset position comprises
measuring a voltage corresponding to a charge stored on the first electrode; and
comparing the measured voltage to a predetermined voltage corresponding to the proof mass reaching the preset position.

3. The method of claim 2, wherein measuring the time comprises measuring, using a digital delay line circuit to measure a time between an edge of the first periodic voltage and a time at which the measured voltage equals the predetermined voltage.

4. The method of claim 2, wherein measuring the voltage comprises measuring the voltage using a charge amplifier.

5. The method of claim 1, comprising periodically applying a second voltage to a second electrode positioned proximate to the proof mass, wherein the second electrode is positioned on a side of the proof mass opposite to the first electrode, and wherein the application of the second voltage is synchronized with the application of the first periodic voltage to the first electrode.

6. The method of claim 5, wherein the application of the second voltage generates an electrostatic force on the proof mass that fully offsets the electrostatic force generated by the application of the first periodic voltage.

7. The method of claim 5, comprising determining the magnitudes of the first and second periodic voltages after manufacture of the accelerometer.

8. The method of claim 1, wherein measuring the time comprises measuring the time by a digital delay line circuit.

9. The method of claim 1, wherein the measured time ranges from around 1 picosecond to around 100 picoseconds.

10. The method of claim 1, wherein the proof mass has a mass ranging from around 1 nanogram to around 100 nanograms.

11. The method of claim 1, comprising automatically calibrating one or more parameters of the accelerometer to improve accuracy of a measurement provided by the accelerometer.

12. The method of claim 10, wherein automatically calibrating one or more parameters of the accelerometer comprises determining at least one of a resonant frequency, an effective resonant frequency, and a mechanical quality factor of the accelerometer.

13. A method for operating a MEMS accelerometer having a proof mass, comprising
periodically applying a first voltage to a first electrode positioned proximate to the proof mass, thereby applying an electrostatic force to the proof mass to draw the proof mass towards the first electrode;
receiving an external acceleration at the accelerometer, wherein the external acceleration alters a time the proof mass takes to reach a preset speed in response to the applied voltage;
determining that the proof mass has reached the preset speed;
measuring a time taken for the proof mass to reach the preset speed;
determining a magnitude and direction of the external acceleration based on the measured time.

14. The method of claim 1, wherein determining that the proof mass has reached the preset speed comprises
measuring a voltage corresponding to a current to the first electrode;
comparing the measured voltage to a predetermined voltage corresponding to the proof mass reaching the preset speed.

15. The method of claim 14, wherein measuring the time comprises measuring, using a digital delay line circuit to measure a time between an edge of the first periodic voltage and a time at which the measured voltage equals the predetermined voltage.

16. The method of claim 14, wherein measuring the voltage comprises measuring the voltage using a current to voltage converter.

17. The method of claim 1, comprising periodically applying a second voltage to a second electrode positioned proximate to the proof mass, wherein the second electrode is positioned on a side of the proof mass opposite to the first electrode, and wherein the application of the second voltage is synchronized with the application of the first periodic voltage to the first electrode.

18. The method of claim 17, wherein the application of the second voltage generates an electrostatic force on the proof mass that fully offsets the electrostatic force generated by the application of the first periodic voltage.

19. The method of claim 17, comprising determining the magnitudes of the first and second periodic voltages after manufacture of the accelerometer. 10

20. The method of claim 13, wherein measuring the time comprises measuring the time by a digital delay line circuit.

21. The method of claim 13, wherein the measured time ranges from around 1 picosecond to around 100 picoseconds.

22. The method of claim 13, wherein the proof mass has a mass ranging from around 1 nanogram to around 100 nanograms.

23. The method of claim 13, comprising automatically calibrating one or more parameters of the accelerometer to improve accuracy of a measurement provided by the accelerometer.

24. The method of claim 13, wherein automatically calibrating one or more parameters of the accelerometer comprises determining at least one of a resonant frequency, an effective resonant frequency, and a mechanical quality factor of the accelerometer.

25. An apparatus for analyzing acceleration of a proof mass of a MEMS accelerometer having a proof mass, comprising
a first voltage source for periodically applying a first voltage to a first electrode positioned proximate to the proof mass, thereby applying an electrostatic force to the proof mass to draw the proof mass towards the first electrode ;
a first comparator for comparing a voltage corresponding to the speed of the proof mass to a predetermined voltage to determine that the proof mass has reached a preset speed;
a digital delay line circuit for measuring a time taken for the proof mass to reach the preset speed;
a processor for determining a magnitude and direction of an external acceleration applied to the accelerometer based on the measured time.

26. An apparatus for analyzing acceleration of a proof mass of a MEMS accelerometer having a proof mass, comprising
a first voltage source for periodically applying a first voltage to a first electrode positioned proximate to the proof mass, thereby applying an electrostatic force to the proof mass to draw the proof mass towards the first electrode;
a first comparator for comparing a voltage corresponding to the position of the proof mass to a predetermined voltage to determine that the proof mass has reached a preset position;
a digital delay line circuit for measuring a time taken for the proof mass to reach the preset position;
a processor for determining a magnitude and direction of an external acceleration applied to the accelerometer based on the measured time.

27. A method for operating a MEMS accelerometer having a proof mass, comprising
applying a first voltage to a first electrode positioned proximate to the proof mass, thereby applying an electrostatic force that induces vibration of the proof mass at a first resonant frequency, and subsequently displaces the proof mass by a first displacement;
applying a second voltage to the first electrode positioned proximate to the proof mass, thereby applying an electrostatic force that induces vibration of the proof mass at a second resonant frequency, and subsequently displaces the proof mass by a second displacement;
applying a third voltage to the first electrode positioned proximate to the proof mass, thereby applying an electrostatic force that induces vibration of the proof mass at a third resonant frequency, and subsequently displaces the proof mass by a third displacement, wherein the third periodic voltage is a multiple of the second periodic voltage;
determining an offset relating to a rest position for the proof mass based on the applied periodic voltages, the resonant frequencies, and the displacements.

28. The method of claim 27, further comprising
applying the first voltage to the first electrode positioned proximate to the proof mass;
receiving an external acceleration at the accelerometer, wherein the external acceleration alters displacement of the proof mass to a new displacement;
determining the new displacement of the proof mass;
determining a magnitude of the external acceleration based on the first resonant frequency, the determined offset, and the new displacement.

29. The method of claim 1, wherein the proof mass comprises at least one layer of metal.
